(19) United States
(12) Patent Application Publication
(10) Pub. No.: US 2008/0201349 A1
(43) Pub. Date: Aug. 21, 2008

(54) RULE CONDITIONS AND DYNAMIC CONTENT ALTERATIONS IN A CONTENT MANAGEMENT SYSTEM

(76) Inventor: John Edward Petri, Lewiston, MN (US)

Correspondence Address: MARTIN & ASSOCIATES, LLC, P.O. BOX 548, CARTHAGE, MO, 64836-0548, US

(21) Appl. No.: 11/675,153

(22) Filed: Feb. 15, 2007

(51) Int. Cl. G06F 17/00

(52) U.S. Cl. 707/102; 707/E17.005

(57) ABSTRACT

A content management system (CMS) includes rule conditions that determine when the rules are applied, and additionally includes alteration instructions for dynamically changing content in the repository and alteration conditions that determine when the alteration instructions will be executed. Rule conditions and alteration conditions may include values from metadata related to content, values from anywhere in the content, values from the metadata of objects linked into the content, values from anywhere in the content of objects linked into the content, the user's current role, or literal values. Rule conditions and alteration conditions may also include various operators, including equals, not equals, greater than, less than, greater than or equal, less than or equal, contains, exists, and starts with, along with the negation of each of these operators. Providing rule conditions and alteration instructions and conditions provides great flexibility and power that greatly improves the functionality of a CMS.

### BACKGROUND

1. Technical Field

This disclosure generally relates to content management systems, and more specifically relates to a content management system that allows specifying conditions for rules so the rules may be selectively applied depending on specified conditions, and that allows specifying alteration instructions and conditions for dynamically changing content in the content management system when a rule is satisfied.

2. Background Art

A content management system (CMS) allows many users to efficiently share electronic content such as text, audio files, video files, pictures, graphics, etc. Content management systems typically control access to content in a repository. A user may generate content, and when the content is checked into the repository, the content is checked by the CMS to make sure the content conforms to predefined rules. A user may also check out content from the repository, or link to content in the repository while generating content. The rules assure that content to be checked in or linked to meets desired criteria specified in the rules. The rules in known content management systems are static, meaning they do not change until a system administrator decides to make a manual change to the rules.

Known content management systems check their rules when content is being checked in. If the rule is satisfied, the content is checked in to the repository. If the rule is not satisfied, the content is not checked in to the repository. Rules may be used for other things as well, such as rules that govern what content in a repository a user may link to in a document that will be subsequently checked in to the repository. In some cases, flexibility in the rules is needed. Known content management systems provide rather rigid rules that are uniformly applied, and do not allow for rules to be selectively applied based on defined conditions. Without a way to more flexibly apply rules and to dynamically alter content according to defined criteria, content management systems will lack the ability to perform many functions that would be powerful and beneficial to users.

### BRIEF SUMMARY

A content management system (CMS) includes rule conditions that determine when the rules are applied, and additionally includes alteration instructions for dynamically changing content in the repository and alteration conditions that determine when the alteration instructions will be executed. Rule conditions and alteration conditions may include values from metadata related to content, values from anywhere in the content, values from the metadata of objects linked into the content, values from anywhere in the content of objects linked into the (main) content (e.g., if the linked in object is also XML), the user's current role, or literal values. Rule conditions and alteration conditions may also include various operators, including equals, not equals, greater than, less than, greater than or equal, less than or equal, contains, exists, and starts with, along with the negation of each of these operators. Providing rule conditions and alteration instructions and conditions provides great flexibility and power that greatly improves the functionality of a CMS.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a networked computer system that includes a server computer system that has a content management system that includes rules, rule conditions, alteration instructions, and alteration conditions;

FIG. 2 is a flow diagram of a prior art method for a known inventory control system;

FIG. 3 is a table showing sample rules for a prior art content management system;

FIG. 4 shows a sample XML document;

FIG. 5 shows the sample XML document in FIG. 4 after checking the document into the prior art content management system that uses method 200 in FIG. 2 and rules 300 in FIG. 3;

FIG. 6 shows a sample object in a content management system that contains the Sneeze_Free.jpg image;

FIG. 7 shows a sample object in a content management system that contains the Drip_Free.jpg image;

FIG. 8 shows a sample object in a content management system that contains a portion of an XML document;

FIG. 9 is a flow diagram of a method for applying rule conditions, alteration instructions, and alteration conditions in the content management system in FIG. 1;

FIG. 10 is a table showing sample rules 180, rule conditions 182, alteration instructions 184, and alteration conditions 186; and

FIG. 11 shows the sample XML document in FIG. 4 after checking the document into the content management system 170 in FIG. 1 that preferably executes method 900 in FIG. 9 according to the table 1000 in FIG. 10.

### DETAILED DESCRIPTION

The claims and disclosure herein provide a content management system that has rules similar to those in known content management systems, but additionally includes rule conditions that determine when the rules are selectively applied, alteration instructions that determine how content in the repository is dynamically altered, and alteration conditions that determine when alteration instructions are executed. The added rule conditions, alteration instructions, and alteration conditions provide a content management system that is much more powerful and flexible than known content management systems.

Many known content management systems use extensible markup language (XML) due to its flexibility and power in managing diverse and different types of content. One known content management system that uses XML is Solution for Compliance in a Regulated Environment (SCORE) developed by IBM Corporation. XML is growing in popularity, and is quickly becoming the preferred format for authoring and publishing. While the disclosure herein discusses XML documents as one possible example of content that may be managed by a content management system, the disclosure and claims herein expressly extend to content management systems that do not use XML.

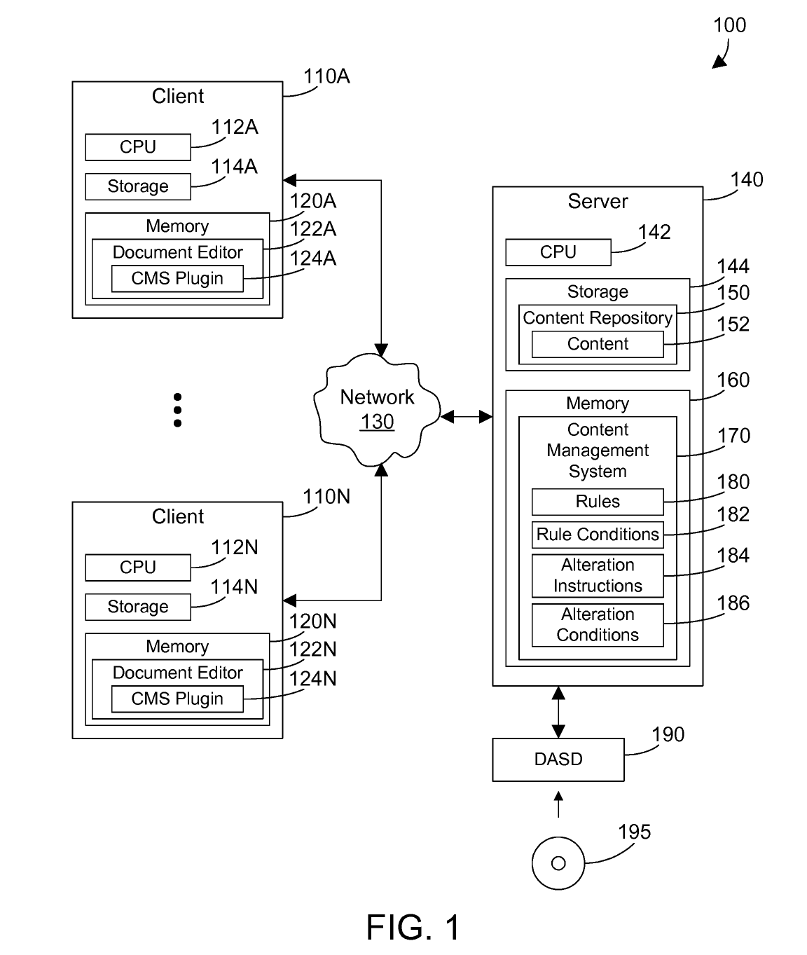

Referring to FIG. 1, networked computer system 100 includes multiple clients, shown in FIG. 1 as clients 110A, . . . , 110N, coupled to a network 130. Each client preferably includes a CPU, storage, and memory that contains a document editor and a content management system (CMS) plugin. Thus, client 110A includes a CPU 112A, storage 114A, memory 120A, a document editor 122A in the memory 120A that is executed by the CPU 112A, and a CMS plugin 124A that allows the document editor 122A to interact with content 152 in the repository 150 that is managed by the CMS 170. In similar fashion, other clients have similar components shown in client 110A, through client 110N, which includes a CPU 112N, storage 114N, memory 120N, a document editor 122N, and a CMS plugin 124N.

The CMS 170 resides in the main memory 160 of a server computer system 140 that also includes a CPU 142 and storage 144 that includes a content repository 150 that holds content 152 managed by the CMS 170. One example of a suitable server computer system 140 is an IBM eServer System i computer system. However, those skilled in the art will appreciate that the disclosure herein applies equally to any type of client or server computer systems, regardless of whether each computer system is a complicated multi-user computing apparatus, a single user workstation, or an embedded control system. CMS 170 includes rules 180, rule conditions 182, alteration instructions 184, and alteration conditions 186. Rule conditions 182 specify at least one criterion for accessing corresponding content 152 in the repository 150. Rule conditions 182 correspond to the rules 180 and specify when the rules 180 are applied. Alteration instructions 184 provide instructions that dynamically alter content 152 in the repository 150. Alteration conditions 186 determine when a corresponding alteration instruction is executed to dynamically alter the content 152 in the repository 150.

In FIG. 1, repository 150 is shown separate from content management system 170. In the alternative, repository 150 could be within the content management system 170. Regardless of the location of the repository 150, the content management system 170 controls access to content 152 in the repository 152.

Server computer system 140 may include other features of computer systems that are not shown in FIG. 1 but are well-known in the art. For example, server computer system 140 preferably includes a display interface, a network interface, and a mass storage interface to an external direct access storage device (DASD) 190. The display interface is used to directly connect one or more displays to server computer system 140. These displays, which may be non-intelligent (i.e., dumb) terminals or fully programmable workstations, are used to provide system administrators and users the ability to communicate with server computer system 140. Note, however, that while a display interface is provided to support communication with one or more displays, server computer system 140 does not necessarily require a display, because all needed interaction with users and other processes may occur via the network interface.

The network interface is used to connect the server computer system 140 to multiple other computer systems (e.g., 110A, . . . , 110N) via a network, such as network 130. The network interface and network 130 broadly represent any suitable way to interconnect electronic devices, regardless of whether the network 130 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The mass storage interface is used to connect mass storage devices, such as a direct access storage device 190, to server computer system 140. One specific type of direct access storage device 190 is a readable and writable CD-RW drive, which may store data to and read data from a CD-RW 195.

Main memory 160 preferably contains data and an operating system that are not shown in FIG. 1. A suitable operating system is a multitasking operating system known in the industry as i5/OS; however, those skilled in the art will appreciate that the spirit and scope of this disclosure is not limited to any one operating system. In addition, server computer system 140 utilizes well known virtual addressing mechanisms that allow the programs of server computer system 140 to behave as if they only have access to a large, single storage entity instead of access to multiple, smaller storage entities such as main memory 160, storage 144 and DASD device 190. Therefore, while data, the operating system, and content management system 170 may reside in main memory 160, those skilled in the art will recognize that these items are not necessarily all completely contained in main memory 160 at the same time. It should also be noted that the term “memory” is used herein generically to refer to the entire virtual memory of server computer system 140, and may include the virtual memory of other computer systems coupled to computer system 140.

CPU 142 may be constructed from one or more microprocessors and/or integrated circuits. CPU 142 executes program instructions stored in main memory 160. Main memory 160 stores programs and data that CPU 142 may access. When computer system 140 starts up, CPU 142 initially executes the program instructions that make up the operating system.

Although server computer system 140 is shown to contain only a single CPU, those skilled in the art will appreciate that a content management system 170 may be practiced using a computer system that has multiple CPUs. In addition, the interfaces that are included in server computer system 140 (e.g., display interface, network interface, and DASD interface) preferably each include separate, fully programmed microprocessors that are used to off-load compute-intensive processing from CPU 142. However, those skilled in the art will appreciate that these functions may be performed using I/O adapters as well.

At this point, it is important to note that while the description above is in the context of a fully functional computer system, those skilled in the art will appreciate that the content management system 170 may be distributed as an article of manufacture in a variety of forms, and the claims extend to all suitable types of computer-readable media used to actually carry out the distribution, including recordable media such as floppy disks and CD-RW (e.g., 195 of FIG. 1).

Embodiments herein may also be delivered as part of a service engagement with a client corporation, nonprofit organization, government entity, internal organizational structure, or the like. These embodiments may include configuring a computer system to perform some or all of the methods described herein, and deploying software, hardware, and web services that implement some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

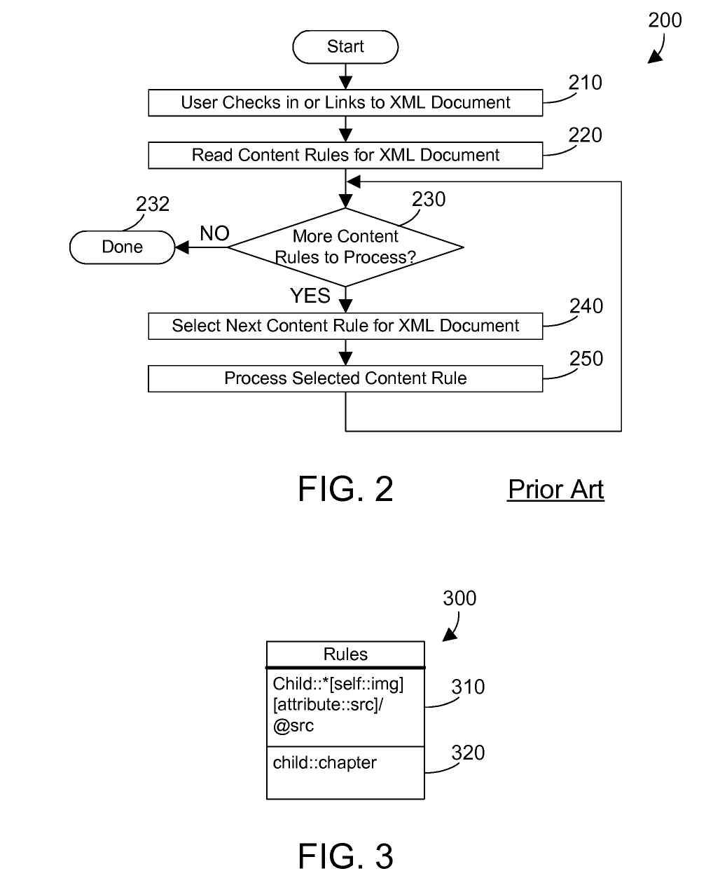

Referring to FIG. 2, a flow diagram shows a prior art method 200 that is used by known content management systems that handle content in the form of XML documents. Method 200 begins when a user checks in an XML document to the repository, or links to an XML document in the repository (step 210). If there are corresponding content rules for the XML document being checked in or linked to, these content rules are read (step 220). If there are more content rules to process (step 230=YES), the next content rule for the XML document is selected (step 240), and the selected content rule is processed (step 250). Method 200 then loops back to step 230, and if there are more content rules to process (step 230=YES), steps 240 and 250 are repeated for the next content rule, and so on until there are no more content rules to process (step 230=NO), at which point method 200 is done (step 232).

Sample content rules similar to those known in the art are shown in table 300 in FIG. 3. These two content rules are Xpath expressions that identify a link/burst location within a source XML document. XPath is a standard XML grammar/language for locating information within an XML document. A simple XPath expression is similar to a file path on a PC for finding a document. In other words, it is used to locate data in the XML from a particular context (such as the root element). For example, /root/title would return the title element that is the child of the root element of an XML document. To understand the example in FIGS. 2-8, linking and bursting in a known CMS needs to be explained. Many content management systems recognize that one way to increase the power of a CMS is to chop content up into smaller chunks that will increase the likelihood that these chunks may be reused for another document. This is known in the art as bursting or chunking. For simplicity herein, we call this bursting, recognizing that different terms apply today to this process and new terms may be developed in the future for this process. When an XML document is checked in to a repository controlled by a CMS, the CMS may use rules to determine how to burst the XML document into smaller portions. Bursting requires linking in the original XML document. In essence, an XML document may be dissected up into component chunks (or objects), with each chunk now having its own identity in the repository. Once each chunk has its own identity in the repository, a chunk that was previously in the original XML document may be replaced by a link to the chunk in the repository. We see from this discussion that bursting inherently requires linking, so the content that was bursted may be stored in the repository and that content in the original XML document may be replaced by a link to the chunk in the repository.

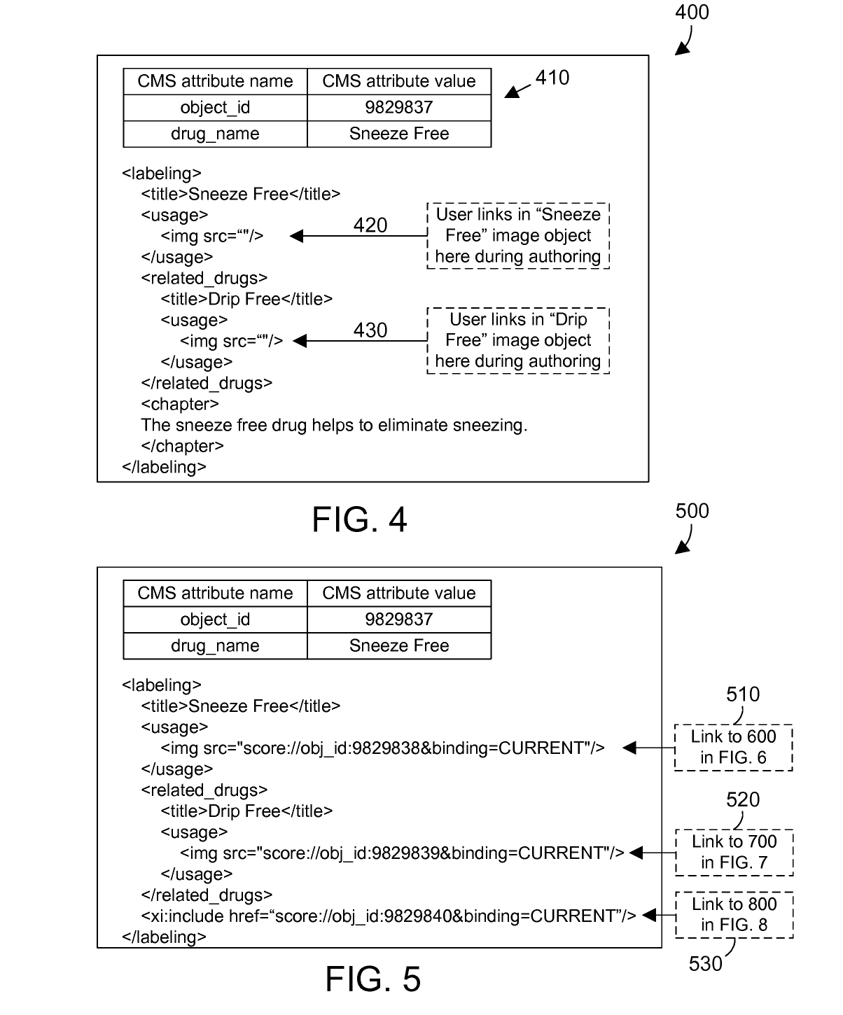

Table 300 in FIG. 3 includes two rules 310 and 320. Rule 310 specifies that images identified by the “img” element with a “src” attribute are allowed to be linked or bursted. Rule 310 indicates that in this case the src attribute contains the information that should be extracted by the system when the rule is processed. Rule 320 specifies that content in chapters should be bursted. We assume that content rules 310 and 320 apply to the sample XML document 400 shown in FIG. 4.

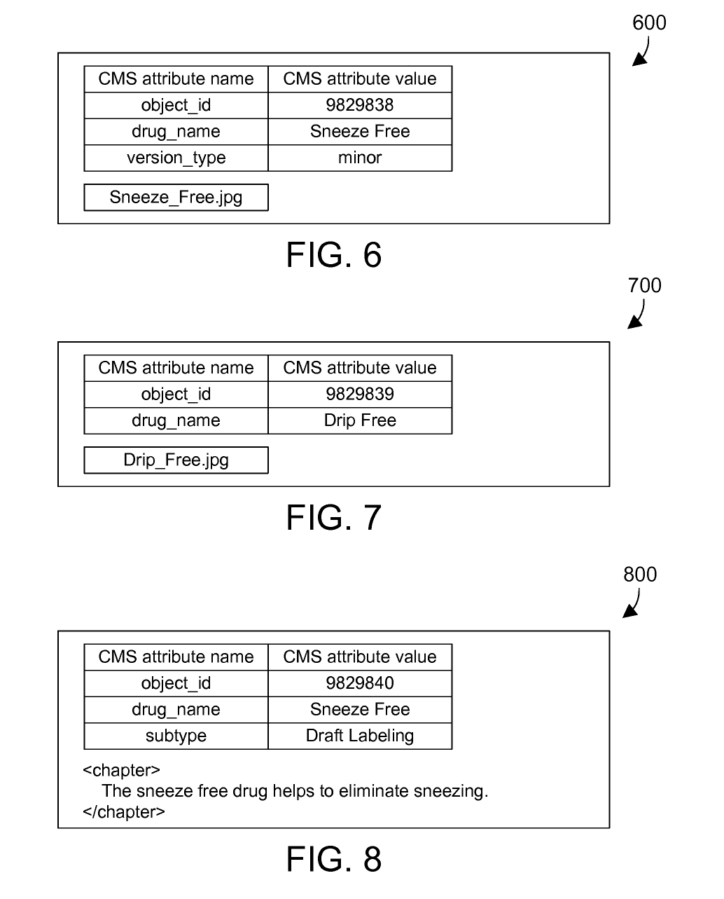

We now consider the sample XML document 400 in FIG. 4. We assume XML document 400 has been checked into the repository previously, which resulted in the XML document receiving attributes and values in table 410 that uniquely identifies XML document 400 in the repository. The object_id in table 410 is 9829837, which is a unique numerical identifier assigned by the CMS when the object was checked into the repository for the first time. The drug_name in table 410 is Sneeze Free. We now assume a user at a client computer system checks out XML document 400, links in an image object for Sneeze Free at 420, and links in an image object for Drip Free at 430. We assume this document is then checked back into the repository, which causes the CMS to run method 200 in FIG. 2. The content rules 310 and 320 in FIG. 3 are read. As the document is checked in, the rules 310 and 320 are applied to determine how to burst and/or to create links for the document. The result of running rules 310 and 320 against the XML document 400 in FIG. 4 is shown in document 500 in FIG. 5. Rule 310 specifies that images may be linked. We assume the image for Sneeze Free stored in the repository 150 as object 600 shown in FIG. 6. This object includes the object_id of 9829838, a drug_name of Sneeze Free, a version_type of minor, with the image Sneeze_Free.jpg as the image contained in this object. A link to object 600 is then inserted into the XML document, as shown at 510 in FIG. 5. In similar fashion, rule 310 also allows linking of the Drip Free image. The image for Drip Free is stored in the repository 150 as object 700 shown in FIG. 7, and a link to object 700 is inserted in the XML document 500 as shown at 520. Rule 320 requires chapters to be bursted, so the chapter is bursted as object 800 shown in FIG. 8. Note that table 810 includes an additional attribute subtype that has a value of Draft Labeling to indicate the chapter information is used on a label that is still in the draft stage. The object 800 includes the chapter, and the chapter in the XML document 500 is replaced by a link to object 800 at 530 in FIG. 5.

The simple example shown in FIGS. 2-8 illustrate graphically how prior art content management systems always apply the rules when content is checked in or linked to. Note, however, the power and flexibility of a content management system could be greatly enhanced if the rules could be conditionally applied depending on specified conditions. In addition, the power and flexibility of a CMS could be further enhanced by specifying alteration instructions that dynamically alter content in a corresponding document, and by specifying alteration conditions that determine when the alteration instructions are executed. The enhanced power and flexibility of a CMS that includes rule conditions, and that may additionally include alteration instructions and alteration conditions, are the subject matter of the disclosure and claims herein.

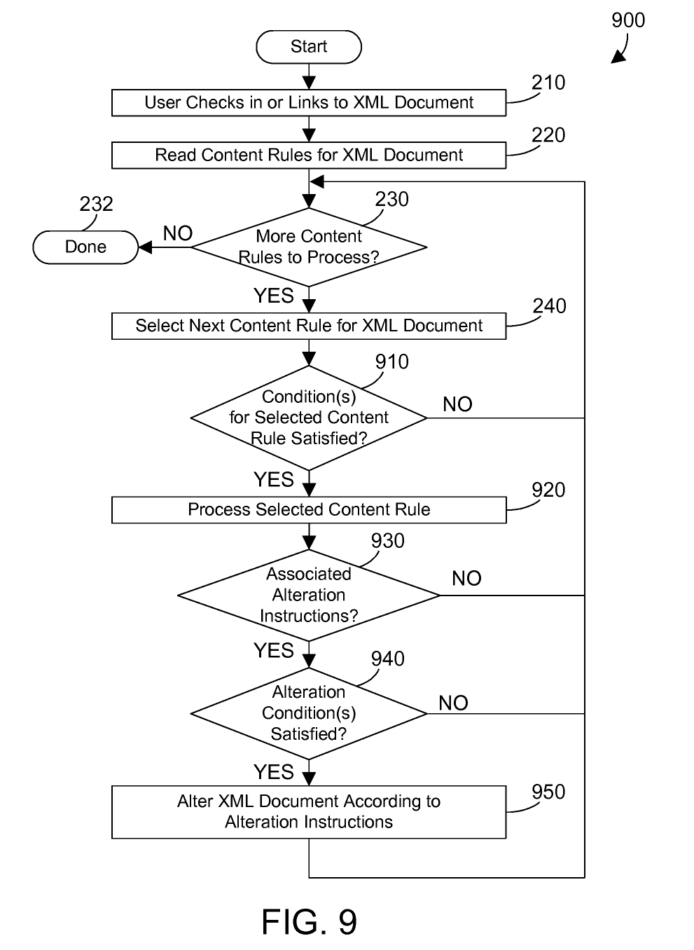

Referring to FIG. 9, a method 900 is preferably performed by the content management system 170 shown in FIG. 1. Note that steps 210, 220, 230, 232 and 240 are preferably the same as in prior art method 200 shown in FIG. 1. Method 200 begins when a user checks in an XML document to the repository, or links to an XML document in the repository (step 210). If there are corresponding content rules for the XML document being checked in or linked to, these content rules are read (step 220). If there are more content rules to process for the XML document (step 230=YES), the next content rule for the XML document is selected (step 240). Method 900 does not always process the content rules as is the case in step 250 in the prior art method 200 of FIG. 2. Instead, method 900 determined whether conditions for the selected content rule are satisfied (step 910). Note that conditions for the selected content rule may include no conditions, which means the conditions are always satisfied (step 910=YES) and the selected content rule will always be processed (step 920). However, conditions may also be specified that must be satisfied for the selected content rule to be applied. If there are specified conditions for the selected content rule that are not satisfied (step 910=NO), the content rule is not processed, and method 900 loops back to step 230. If the conditions for the selected content rule are satisfied (step 910=YES), the selected content rule is satisfied (step 920). By providing rule conditions that correspond to content rules, method 900 allows selectively applying the content rules instead of always applying the content rules.

Method 900 includes additional steps that may optionally be performed as desired. Once the selected content rule is processed in step 920, method 900 determines whether there are associated alteration instructions that correspond to the selected content rule (step 930). If not (step 930=NO), method 900 loops back to step 230 and continues. If there are associated alteration instructions that correspond to the selected content rule (step 930=YES), method 900 checks to see if there are alteration conditions that correspond to the alteration instructions (step 940). If there are no alteration conditions specified, the alteration conditions are always satisfied (step 940=YES), which results in the XML document being dynamically altered according to the alteration instructions (step 950). If there is one or more alteration condition specified, and if all of the alteration conditions are not satisfied (step 940=NO), the alteration instructions are not executed, and method 900 loops back to step 230 and continues. If there is one or more alteration condition specified and if all of the alterations conditions are satisfied (step 940=YES), the XML document is altered according to the alteration instructions (step 950). Method 900 then loops back to step 230, and if there are more content rules to process (step 230=YES), method 900 continues at step 240 for the next content rule, and so on until there are no more content rules to process (step 230=NO), at which point method 900 is done (step 232).

A detailed example is now given to show how adding rule conditions, alteration instructions, and alteration conditions creates a content management system that is more powerful and flexible than known content management systems. Let's assume a person we'll call Employee A works for a pharmaceutical company and is responsible for creating a new drug product label. The labeling document is an XML document conforming to the FDA's Structure Product Labeling (SPL) schema, which allows for a mixture of text and images. The images Employee A plans to use in the document (e.g., molecular diagrams, usage charts/graphs, etc.) were developed by lab scientists using an outside software application, and therefore were imported into the repository as their own objects at an earlier time. At the appropriate places in the document, Employee A chooses to link in these images. The CMS plugin (e.g., 124A in document editor 122A in FIG. 1) allows Employee A to interact with the repository, for example by allowing Employee A to browse or search the repository for objects, such as text and images, to link into the XML document for the new drug label.

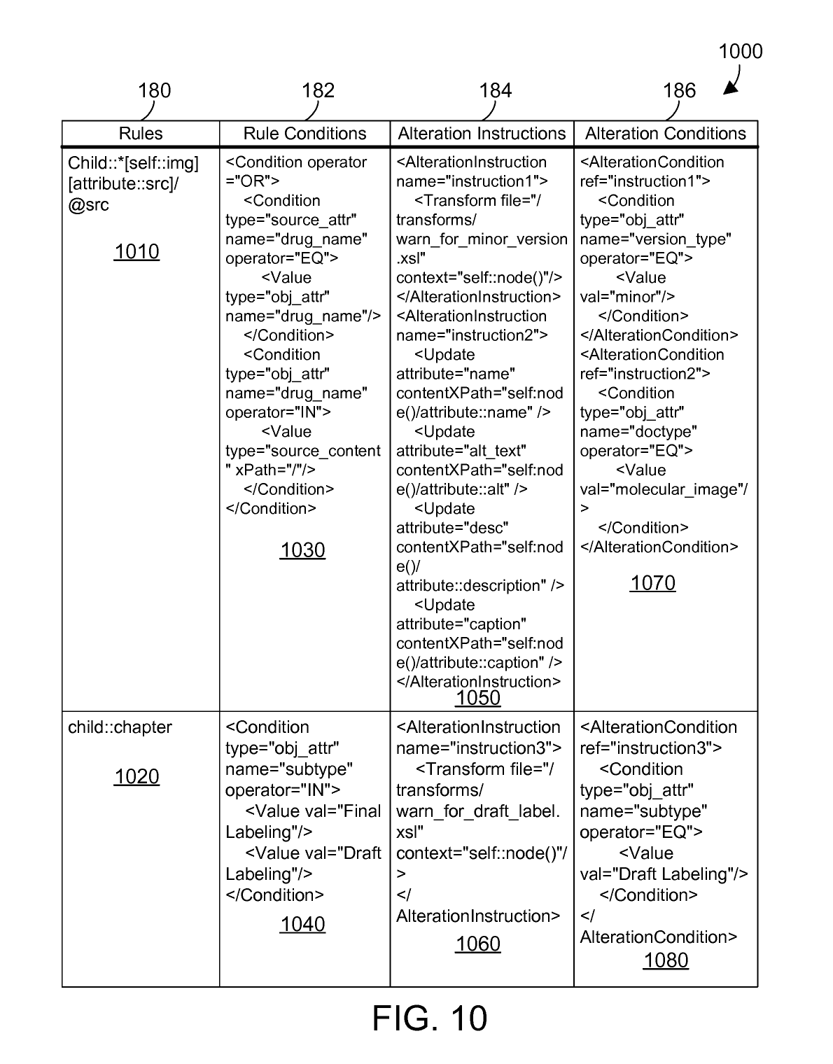

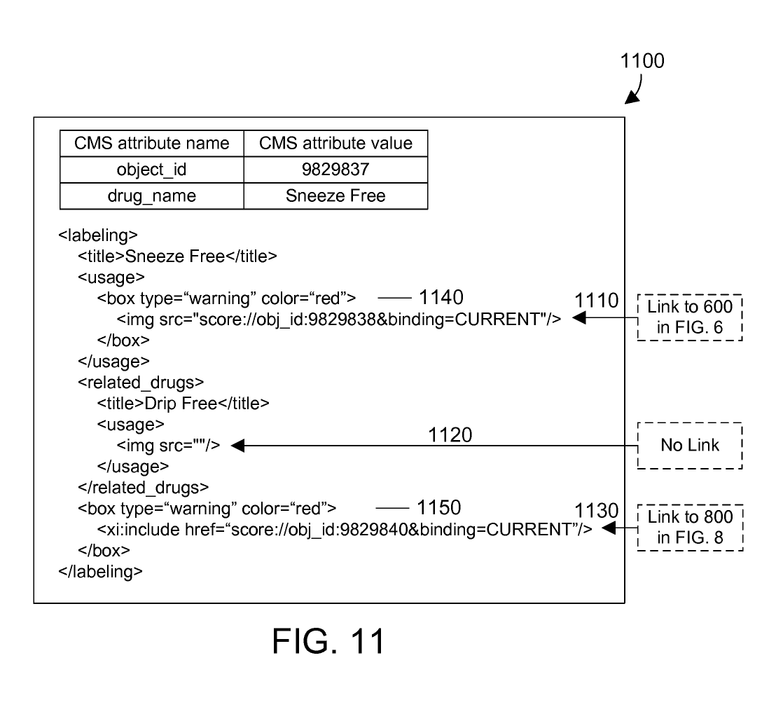

Next let's assume that two months later, the scientists who created one of the molecular diagrams realize they made a mistake in the diagram. They create a new draft version of the image to make their change. However, since the earlier version of the image has been in production for two months, they are worried about the repercussions of simply approving this new draft version of the image without seeing how it affects other documents that link to it. Therefore, they would like to review the changes to this image in the context of the documents that link to it (e.g. Employee A's document). However, per the company's business rules, not all users are authorized to access draft images. For instance, only system administrators should be able to do this. Accordingly, there is a need for conditioning of the content rules based on user role in this case. If Employee A is in the administrator role, Employee A can link in any version (including minor, or draft versions) of an object. But if Employee A is not an administrator, Employee A should only be able to link in “final” versions of an object. Therefore when it comes time to test and review changes to the new molecular diagram, an administrator should be the only one allowed to make the change to use the new draft version. Rules conditions may be used to enforce this. In addition, after an administrator links in the scientists' new draft version of the image, it would be very useful if additional post-processing could be performed against the XML. For instance, an XML transformation could occur to indicate that the linked image is not yet “final”. As an example, the XML could be altered to include a red box around the image with the warning label: “Notice: this image is not the final version.” How to implement this type of rule conditioning and alteration instructions and conditions will be illustrated in the detailed example shown in FIGS. 10 and 11 and discussed below.

Referring to FIG. 10, a table 1000 contains rules 180, rule conditions 182, alteration instructions 184, and alteration conditions 186. For simplicity, table 1000 in FIG. 10 contains only two rows, but in reality, table 1000 may contain as many rows as necessary. The rules 180 include rules 1010 and 1020, which are the same as rules 310 and 320 shown in table 300 in FIG. 3. Rule conditions 182 include rule conditions 1030 that correspond to rule 1010 and rule conditions 1040 that correspond to rule 1020. Rule conditions 182 describe conditions that must be met in order for either the specified element to be bursted, or an object to be linked into the document at the specified link/burst XPath. Alteration instructions 1050 correspond to rule 1010 and alteration instructions 1060 correspond to rule 1020. Similarly, alteration conditions 1070 correspond to alteration instructions 1050, which correspond to rule 1010, and alteration conditions 1080 correspond to alteration instructions 1060, which correspond to rule 1020.

We see from rule conditions 1030 and 1040 and alteration conditions 1070 and 1080 that these conditions may include numerous different values and numerous different operators. The rule conditions 182 and alteration conditions 186 expressly include any suitable value and any suitable operator. Examples of suitable values include values from metadata related to content, values from anywhere in the content, values from the metadata of objects linked into the content, values from anywhere in the content of objects linked into the (main) content (e.g., if the linked in object is also XML), the user's current role, and literal values. Examples of suitable operators include equals, not equals, greater than, less than, greater than or equal, less than or equal, contains, exists, and starts with, along with the negation of the aforementioned operators.

Rule conditions 1030 specify that either the source document's drug_name attribute must be equal to the linked object's drug_name attribute OR the linked object's drug_name must appear somewhere in the source document's content. Note in the case of bursting this element at import time, the linked object will not yet exist in the repository and so the condition which references the object's drug_name attribute will be empty. However, in this case the CMS 170 can retrieve this value from the linking rule associated with this element, as the rule defines the default attributes that will be applied when the element is bursted. Rule conditions 1040 specify that the document's subtype attribute must be in either “Final Labeling” or “Draft Labeling” for a chapter to be bursted or linked.

Alteration instructions 1050 indicate how the source XML document should be altered when the corresponding alteration conditions 1070 are satisfied. Alteration instructions 1050 include a first instruction called “instruction1” that indicates that an XSL template called warn_for_minor_version.xls should be invoked to alter the current XML document, and a second instruction called “instruction2” that identifies several updates to be made to XML attributes in the object using CMS attribute values. Alteration instructions 1060 indicate how the source XML document should be altered when the corresponding alteration conditions 1080 are satisfied. Alteration instructions 1060 include a third instruction called “instruction3” that indicates that an XSL template called warn_for_draft_label.xls should be invoked on the current XML document.

Alteration conditions 1070 describe conditions that must be met in order for the source XML document to be altered by executing the corresponding alteration instructions 1050. Alteration conditions 1070 specify two conditions. The first condition states that the version_type attribute of the linked object must be equal to “minor”. This condition is tied by reference to the alteration instruction named “instruction1” in 1050. The second condition in 1070 specifies that the alteration instruction “instruction2” in 1050 should only be invoked when the doctype of the linked object equals “molecular_image”. Alteration conditions 1080 specify one condition, that the subtype attribute of the linked object must be equal to “Draft Labeling” for “instruction3” in 1060 to be executed.

We now assume the sample XML document in FIG. 4 is checked into the CMS 170 in FIG. 1 that includes the specific rules 180, rule conditions 182, alteration instructions 184 and alteration conditions 186 shown in table 1000 in FIG. 10. The sample rule conditions only allow linking in image objects that have a drug_name attribute equal to the XML document's drug_name attribute. Referring to FIG. 11, the object 600 in FIG. 6 satisfies the rule conditions 1030, and is therefore linked in to document 1100 at 1110 according to rule 1010. The second object 700 in FIG. 7 does not satisfy the rule conditions 1030 because it has a drug_name attribute of Drip Free, which is different than the drug_name attribute of Sneeze Free for the XML document 400 in FIG. 4. Because the object 700 in FIG. 7 does not satisfy the rule conditions 1030, rule 1010 is not applied, and the object 700 is not linked into the document 1100, as shown at 1120 in FIG. 11.

Rule 1020 governs the bursting of a chapter. Because the subtype attribute of the object 800 in FIG. 8 is “Draft Labeling”, the rule conditions 1040 that require a subtype of either “Final Labeling” or “Draft Labeling” are satisfied, so the chapter is bursted from and then linked in document 1100 as shown at 1130 in FIG. 11.

The alteration instructions 1050 and 1060 may also be executed if the corresponding alteration conditions 1070 and 1080 are satisfied. When object 600 in FIG. 6 is linked in at 1110 in document 1100 in FIG. 11, the alteration conditions 1070 corresponding to instructions are satisfied, so instructions in 1050 is executed, which invokes an XSL stylesheet to insert a red warning box around the image, as shown at 1140 in FIG. 11. When object 800 in FIG. 8 is linked in at 1130 in FIG. 11, the alteration conditions 1080 are satisfied because the object has a subtype of “Draft Labeling”, so instruction3 in alteration instructions 1060 is executed, which invokes an XSL stylesheet to insert a red warning box around the chapter, as shown at 1150 in FIG. 11.

The ability to conditionally apply rules in a CMS increases the power and flexibility of the CMS. In addition, the ability to specify alteration instructions and rules provides a very powerful way to dynamically change content according to the alteration instructions when the corresponding alteration conditions are satisfied.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims. For example, while the examples in the figures and discussed above related to XML documents, the disclosure and claims herein expressly extend to content management systems that handle any suitable type of content, whether currently known or developed in the future.

What is claimed is:

1. An apparatus comprising:
at least one processor;
a memory coupled to the at least one processor;
a repository of content in the memory; and
a content management system residing in the memory and executed by the at least one processor, the content management system comprising:
at least one rule that determines at least one criterion for accessing specified content in the repository; and
at least one rule condition corresponding to the at least one rule, the at least one rule condition being separate from the at least one rule and determining when the at least one rule is applied.

2. The apparatus of claim 1 wherein the at least one rule condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

3. The apparatus of claim 1 wherein the content management system applies the at least one rule when the corresponding at least one rule condition is satisfied.

4. The apparatus of claim 1 further comprising at least one alteration instruction that determines how the specified content in the repository is dynamically altered.

5. The apparatus of claim 4 further comprising at least one alteration condition corresponding to at least one alteration instruction, the at least one alteration condition determining when the corresponding at least one alteration instruction is executed to dynamically alter the specified content in the repository.

6. The apparatus of claim 5 wherein the at least one alteration condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

7. A computer-implemented method for managing content in a content management system that controls access to a repository of content, the method comprising the steps of:
receiving a request to access specified content in the repository;
reading at least one rule corresponding to the specified content that determines at least one criterion for accessing the specified content in the repository;
reading at least one rule condition corresponding to each rule that corresponds to the specified content, wherein the at least one rule condition is separate from the corresponding rule and determines when the corresponding rule is applied; and
applying the corresponding rule when the at least one rule condition is satisfied.

8. The method of claim 7 wherein the at least one rule condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

9. The method of claim 7 further comprising the step of:
applying a rule when all rule conditions corresponding to the rule are satisfied.

10. The method of claim 7 further comprising the steps of:
reading at least one alteration instruction that determines how the specified content in the repository is dynamically altered;
reading at least one alteration condition that determines when corresponding alteration instructions are executed to dynamically alter the specified content in the repository; and
executing the at least one alteration instruction when the corresponding at least one alteration condition is satisfied to dynamically alter the specified content in the repository.

11. The method of claim 10 wherein the at least one alteration condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

12. A method for deploying computing infrastructure, comprising integrating computer readable code into a computing system, wherein the code in combination with the computing system perform the method of claim 7.

13. An article of manufacture comprising:
(A) a content management system comprising:
at least one rule that determines at least one criterion for accessing specified content in a repository;
at least one rule condition corresponding to the at least one rule, the at least one rule condition being separate from the at least one rule and determining when the at least one rule is applied; and
(B) computer-readable media bearing the content management system.

14. The article of manufacture of claim 13 wherein the at least one rule condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

15. The article of manufacture of claim 13 wherein the content management system applies the at least one rule when the corresponding at least one rule condition is satisfied.

16. The article of manufacture of claim 13 further comprising at least one alteration instruction that determines how the specified content in the repository is dynamically altered.

17. The article of manufacture of claim 16 further comprising at least one alteration condition corresponding to at least one alteration instruction, the at least one alteration condition determining when the corresponding at least one alteration instruction is executed to dynamically alter the specified content in the repository.

18. The article of manufacture of claim 17 wherein the at least one alteration condition includes:
at least one value selected from at least one of the following: values from metadata related to the specified content, values from anywhere in the specified content, values from metadata of objects linked into the specified content, values from anywhere in content of objects linked into the specified content, a user's current role, and literal values; and
at least one operator selected from at least one of the following: equals, not equals, greater than, less than, greater than or equal, less than or equal, contains, exists, and starts with, and the negation of these.

19. A computer-implemented method for managing content in a content management system that controls access to a repository of content, the method comprising the steps of:
receiving a request to check in a document into the repository, the document including at least one link to a document in the repository, a first portion that may be bursted to the repository when the document is checked in to the repository, and a second portion that requires synchronization with metadata corresponding to the document;
reading a first rule corresponding to the at least one link that determines at least one criterion for linking to corresponding documents in the repository;
reading a second rule corresponding to the first portion that determines whether to burst the first portion;
reading a third rule corresponding to the second portion that determines whether the second portion and corresponding metadata are synchronized with each other;
reading at least one rule condition corresponding to each rule, wherein the at least one rule condition is separate from the corresponding rule and determines when the corresponding rule is applied;
applying each rule when the corresponding at least one rule condition is satisfied;
determining whether each rule has at least one corresponding alteration instruction;
determining whether each alteration instruction has at least one corresponding alteration condition; and
executing each alteration instruction when the corresponding at least one alteration condition is satisfied.
